(19) United States
(12) Patent Application Publication
(10) Pub. No.: US 2025/0117733 A1
(43) Pub. Date: Apr. 10, 2025

(54) COMPUTER-IMPLEMENTED METHODS AND SYSTEMS FOR PERSONALIZED AUTONOMOUS COACHING

(71) Applicant: Benjamin Traub, Englewood, FL (US)

(72) Inventor: Benjamin Traub, Englewood, FL (US)

(73) Assignee: Inspira AI Corp, Las Vegas, NV (US)

(21) Appl. No.: 18/907,412

(22) Filed: Oct. 4, 2024

Related U.S. Application Data
(60) Provisional application No. 63/588,006, filed on Oct. 5, 2023.

(51) Int. Cl. G06Q 10/0639; G06F 40/00

(52) U.S. Cl. CPC G06Q 10/06398; G06F 40/00

(57) ABSTRACT

According to an aspect of the present invention, there is provided a computer-implemented method for identifying the goals set by users of the system which can be compared with an employee's historical or predicted, behavioural or performance data, and where a threshold-exceeding differential of a comparison may be then used to trigger an LLM-powered, autonomous coaching session that can use the goals and performance and differential data to generate a personalized coaching conversation with the employee.

### BACKGROUND

The present invention generally relates to communication systems, and more particularly, to a computerized communication system for employee coaching in the context of behavioral or performance data. Modern management requires significant time invested into employees for purposes such as monitoring, training, coaching, correction, and so forth. This monitoring, investigation and intervention process is time-consuming and labor-intensive, so much so that granular management is often not possible due to time limitations. The present invention provides an Autonomous Coaching Agent (“ACA)” which programmatically accomplishes coaching tasks, thus reducing the time and effort required by managers in their work of monitoring, training, coaching, motivation or correction of employees, and reporting on all this.

### SUMMARY OF INVENTION

The invention provides a system for an ACA that programmatically decides how and when to trigger coaching conversations with employees, and to autonomously manage the intervention process, including monitoring employee behavior and communicating with and obtaining goal-related feedback from employees.

According to an aspect of the present invention, there is provided a computer-implemented method for comparing goals which have been stored in the system with employee behavioral and performance data and using the differential of the two to act as a trigger to initiate autonomous coaching.

According to another aspect of the present invention, there is provided an autonomous coaching system that responds to programmatic triggers, to initiate a coaching session with the employee utilizing the goal data, the employee's performance data, and the differential of the two, to generate personalized coaching.

According to a third embodiment of the present invention, it is a system for autonomous coaching comprising: at least one display device associated with, and communicatively connected to, a worker computing device; a database stored on a computer-readable medium; and at least one processor operative for: comparing the goals stored in the system, the employee's performance or behavioral data, the differential of the two, on the system's computing device, and if the differential exceed certain thresholds, triggers via a network the initiation of an autonomous coaching conversation on the employee's computing device.

### BRIEF DESCRIPTION OF THE DRAWINGS

FIG. 1 illustrates the basic components for implementing embodiments of the present invention;

FIG. 2 illustrates an example of an autonomous coaching session that utilizes the differential of the goal data and actual performance data to personalize an autonomous coaching session.

FIG. 3 illustrates a summary of users of the system who can create goals; and

FIG. 4 is a schematic drawing of hardware and software architecture for implementing embodiments.

### DETAILED DESCRIPTION

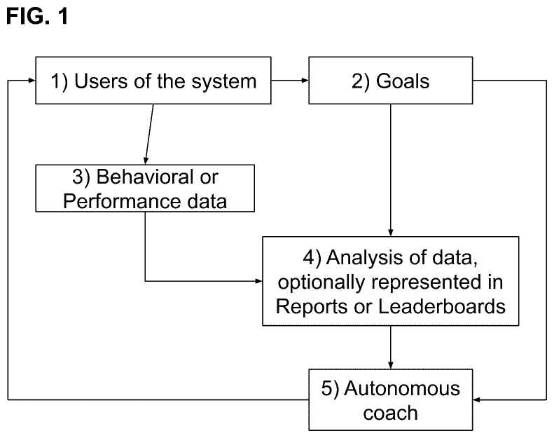

FIG. 1 shows users 1 of the system setting behavioral or performance goals 2 and behavioral or performance data 3 flowing from employee device 1 into storage system 4 where it is analyzed and used to trigger personalized, autonomous coaching 5 with employees.

In an example embodiment, users of the system 1 define the behavioral or performance goals 2 which are stored in the system. Behavioral or performance data flows from employee device 1 into storage 4 where it may be represented in leaderboards or other reports and analyzed 4. Specifically, the analysis process involves goal data 2 being compared with actual performance data 3. When there is a significant differential between goals and performance data, autonomous coaching 5 may be triggered.

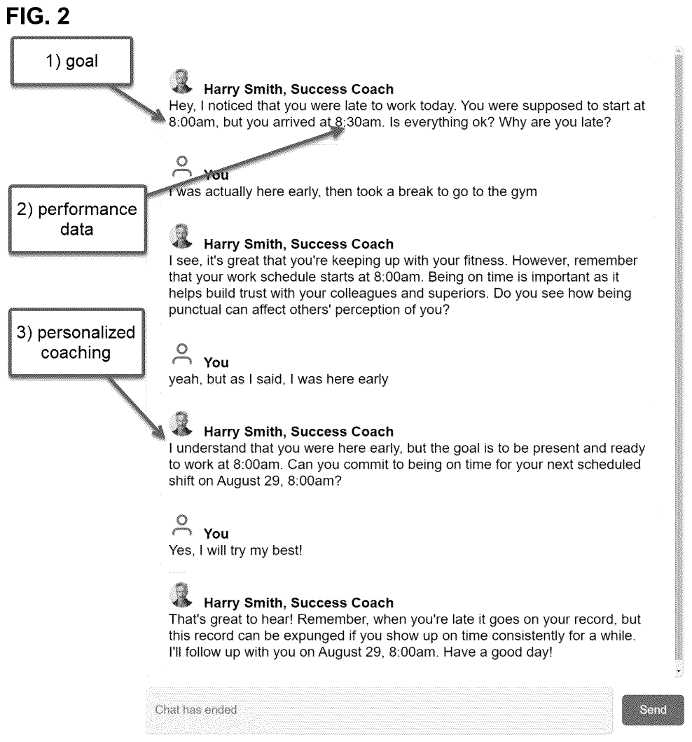

FIG. 2 shows an example coaching session which has been customized using the goal 6 and the performance data 7 to personalize 8 the session for the user.

In an example embodiment, the autonomous coaching system is an LLM-powered chatbot that launches on the employee's computing device and initiates a conversation with the employee, discussing the goal 6 and performance data 7 to generate a personalized coaching 8 message.

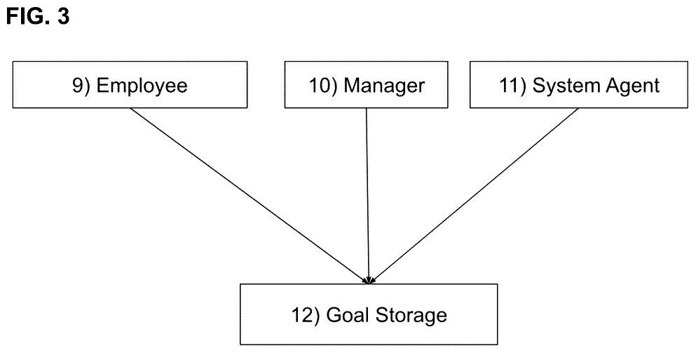

FIG. 3 illustrates users of the system, whether employees 9 or managers 10 or programmatic system agents 11, inputting goal data into a goal storage system.

In an example embodiment, any employee 9 or manager 10 or system agent 11 may be authorized to define and enter goal data into a storage system 12. Notable that system agents 11 are programmatic users of the system, which may include Al agents capable of setting reasonable goals for employees 9.

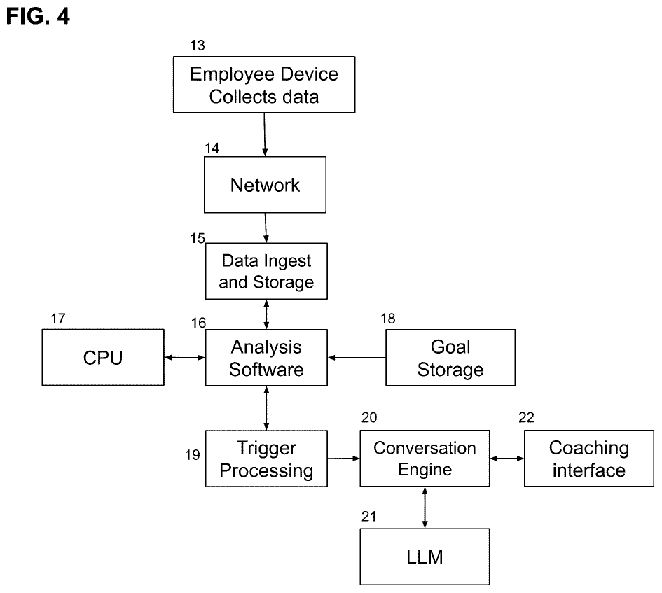

FIG. 4 illustrates how the data flows from an employee computing device 13, which has been collected via any variety of software such as software capable of capturing behavioral and performance data such as visited websites and in-use software applications, using a library such as active-win, and keystrokes or mouse activity using a library such as iohook. This data is sent through a network 14 to a storage system 15 where it can be analyzed with software 16 that can process the data with CPU 17 and other standard compute hardware and compare the performance data against goal data 18. If there is a significant differential, as defined in the analysis software 16, a trigger 19 can be sent to a conversation engine 20, such as a chatbot that is powered by an LLM 21. Accompanying the trigger 19 can be the personalized data to be used by the coaching engine 20, such as goal data, performance data, and/or the differential data. The conversation engine 20 sends conversational details to a coaching interface 22 which is presented to the employee on their computing device 13.

In an example embodiment, the coaching interface 22 is a chat interface that allows the user to interact with an autonomous coach by typing.

In another example embodiment, the coaching interface utilizes voice-to-voice communication facilitated by TTS and STT software.

Independent Claims:

A computer-implemented method for autonomous employee coaching, the method comprising:
a. receiving goal data associated with an employee, wherein the goal data is stored in a database;
b. collecting performance or behavioral data from a computing device associated with the employee;
c. analyzing the collected performance or behavioral data and comparing it with the goal data to generate a differential value;
d. determining whether the differential value exceeds a predefined or dynamic threshold; and
e. in response to determining that the differential value exceeds the threshold, triggering an autonomous coaching session on the employee's computing device, wherein the coaching session includes personalized feedback based on the goal data and the differential value.

An autonomous coaching system for employee development, comprising:
a. at least one employee computing device communicatively connected to a network;
b. a database storing goal data and performance or behavioral data for the employee;
c. a processor configured to:
i. analyze the performance or behavioral data and compare it to the goal data to calculate a differential value;
ii. determine if the differential value exceeds a predefined or dynamic threshold;
iii. trigger a coaching session in response to the differential value exceeding the threshold;
d. a conversation engine configured to deliver personalized coaching sessions on the employee's computing device, wherein the content of the coaching session is based on the goal data, performance data, and the calculated differential.

A system for autonomous coaching, comprising:
a. a storage system communicatively connected to one or more employee computing devices, wherein the storage system stores goal data and performance or behavioral data;
b. a processor configured to:
i. receive and store the goal data and performance or behavioral data;
ii. compare the performance or behavioral data with the goal data to determine a differential;
iii. trigger an autonomous coaching session if the differential exceeds a predefined or dynamic threshold;
c. a conversation engine, operable to deliver the coaching session via a chatbot interface on the employee computing device, wherein the coaching session provides personalized feedback derived from the goal data and the differential.

Dependent Claims:

The method of claim 1, wherein the goal data is input by an authorized manager, employee, or an autonomous programmatic agent.

The method of claim 1, wherein the performance or behavioral data includes one or more of:
a. application usage data,
b. keystroke data,
c. mouse activity data,
d. visited websites, or
e. behavioral data, or
f. task focus metrics, or
g. task completion metrics.

The system of claim 2, further comprising an analysis process that generates a comparison between goal data and performance or behavioral data for employees.

The method of claim 1, wherein the threshold for triggering the coaching session is dynamically assessed by an LLM or based on predefined or historical or predicted employee performance trends or organizational standards.

The system of claim 3, wherein the conversation engine is powered by a large language model (LLM) capable of generating natural language coaching responses based on employee-specific performance data and goals.

The system of claim 3, wherein the coaching interface is a conversation interface allowing real-time interaction between the employee and the autonomous coaching agent.

The method of claim 1, further comprising the step of storing the results of the coaching session and the employee's responses in the database for future analysis.

The system of claim 2, wherein the conversation engine is configured to update or adjust future goal data based on employee progress or feedback from coaching sessions.

The method of claim 1, wherein the personalized coaching content includes suggested actions, tips, or training resources based on the comparison between the goal data and the performance or behavioral data.

The method of claim 1, further comprising notifying a supervisor or manager if the employee's performance or behavior consistently falls below the threshold, despite multiple coaching sessions.
